(19) United States
(12) Patent Application Publication
(10) Pub. No.: US 2004/0070786 A1
(43) Pub. Date: Apr. 15, 2004

(54) Method for interactively transmitting image data over a communication link

(76) Inventor: Timothy Christopher Anthony Molteno, Coralles, NM (US)

Correspondence Address: LIEBERMAN & BRANDSDORFER, LLC, 12221 MCDONALD CHAPEL DRIVE, GAITHERSBURG, MD, 20878, US

(21) Appl. No.: 10/457,668

(22) Filed: Jun. 9, 2003

Related U.S. Application Data
(60) Provisional application No. 60/387,092, filed on Jun. 8, 2002.

(51) Int. Cl. G06F 15/00; B41F 1/00

(52) U.S. Cl. 358/1.15; 358/1.1

(57) ABSTRACT

A method is provided for interactively transmitting image data over a communication link. Typically the image data is communicated between a server and a client connected to each other by the communication link. The method includes the steps of transmitting an initial representation of image data from the server to the client which displays data at full size, receiving further queries using an image query syntax, interpreting the query and measured network performance data and returning further image data to the client. The client incorporates this data and displays an improved representation of the image. The initial representation of the image data could be displayed at lower resolution.

### BACKGROUND OF THE INVENTION

1. Technical Field

The present invention pertains to the field of image-data transfer over communication links. More particularly the present invention relates to a method for decreasing the time required to perform image-data based tasks over communication links.

2. Description of the Prior Art

When an image is transferred over a communication link, it is often the case that significant portions of the image are not pertinent to the task at hand. The system we describe allows the user to interactively transfer subsets of the image data, thereby reducing the total amount of data transferred and potentially decreasing the time required to perform a task based on transfer of image data.

By measuring the latency and bandwidth for each data transfer, and adapting the amount of data subsequently transmitted, the system avoids long delays while the user waits for data to be downloaded. Using this system improvements in quality of service can be attained over existing communication links.

### SUMMARY OF THE INVENTION

The present invention includes a method for transmitting an image from a server to a client over a communication link. The transfer is initiated by the client, and in response, the server transmits of a preview of the image to the client. The format and content of this preview is determined by the server based on user preferences and the measured characteristics of the communication link between server and client. The client displays the preview, and then in response to further user input, the client sends requests for further detail in regions of interest. The server responds with additional image data transmitted to the client from the neighborhood of the specified region. The format and content of this additional image data is determined by the server based on user latency preferences as well as the measured characteristics of the communication link between server and client. Other features of the present invention will be apparent from the accompanying drawings and from the detailed description which follows.

### BRIEF DESCRIPTION OF THE DRAWINGS

The present invention is illustrated by way of example, and not limitation in the figures of the accompanying drawings, in which like references indicate similar elements and in which:

FIG. 1 illustrates two computer systems connected for the purposes of image data transfer.

FIG. 2 illustrates an image displayed on a display device at low resolution with a high resolution region of interest chosen.

FIG. 3 is a flow diagram illustrating one embodiment of a client routine for transferring image data from one processing system to another in accordance with the present invention.

FIG. 4 is a flow diagram illustrating one embodiment of a server routine for transferring image data from one processing system to another in accordance with the present invention.

### DESCRIPTION OF THE PREFERRED EMBODIMENT

A method and apparatus for transmitting image data from a server to a client is described. In the following description, for purposes of explanation, numerous specific details are set forth in order to provide a thorough understanding of the present invention. It will be evident, however, to one skilled in the art that the present invention may be practiced without these specific details. In other instances, well-known structures and devices are shown in block diagram or other symbolic form in order to facilitate description of the present invention.

The present invention allows interactive transfer of image data from one computer to another. The present invention reduces the effective image transfer time by letting the client select which regions of image data will be transmitted first. This interaction between the client and server is a continuous process during transfer of data. By doing this the client can gain detailed knowledge of the image in a time much shorter than transferring the entire image at full resolution.

Briefly, in accordance with the present invention, a user input is received by a client processing system requesting transmission of an image to a remote processing system, the client sends this request to the server. In response, the server measures the current bandwidth of the communication link between the two systems. Based on the properties of the communication link, a low resolution preview image is automatically generated by the server. The size of this response data set is optionally limited to the largest amount of data that can be transmitted over the communication link in a specified time interval. The response data set is transferred to the remote processing system, where the image is displayed at full size, but possibly at a resolution less than full resolution, depending on the resolution of the preview.

The client can then receive user input, requesting further image data in certain regions (regions of interest) which are communicated to the server. In response, the server generates further image data in the region of interest, and transmits this image data to the client. Again, the size of the response data set is optionally limited to the largest amount of data that can be transmitted over the communication link in a specified time interval.

Generation of response image data is made in a manner that is transparent to the user of the client system. However, a user may provide criteria upon which such data are generated, such as a desired maximum image transfer time.

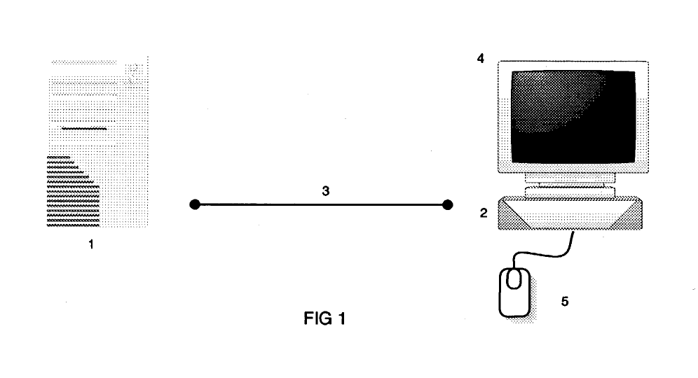

FIG. 1 illustrates two computer systems, a server (1) and a client (2) connected using a communication link to enable image data transfer. The client computer system 2 includes a display device (4), a pointing device (5) and a keyboard (not shown).

Computer systems 1 and 2 are connected to each other by a communication link 3, which may be POTS lines, ISDN connections, digital subscriber line (xDSL) connections, Ethernet connections, or any other suitable type of communication link.

Computer systems 1 and 2 include and execute appropriate interactive image transfer client and server software. An example of such software is the VideoScript interactive image transfer system available from VideoScript Corporation of Corrales, N. Mex.

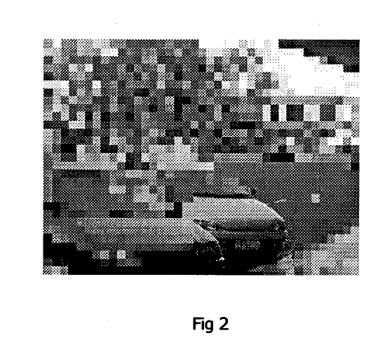

FIG. 2 illustrates an image displayed at low resolution image with a high resolution rectangular region of interest chosen. In other embodiments, the region might be a different shape altogether. Thus the present invention is not limited to any geometry of the region of interest, nor to any algorithm used to determine the resolution of the region of interest.

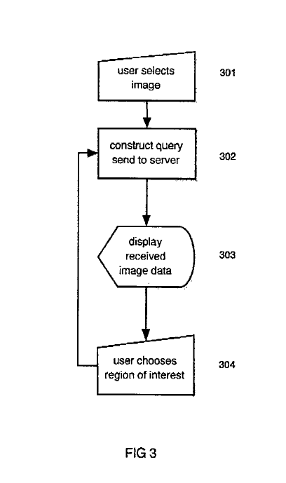

FIG. 3 illustrates one embodiment of a client side decision tree for the present invention. It should be apparent to one of ordinary skill in the art that some of the steps shown can be repeated, and other steps are variations or embellishments of the basic method of the invention, in other words not every step shown is necessary to work the invention.

A user chooses an image (301) from a list, to begin an image exploration session. A query is constructed based on this choice (302) and is sent to the server which receives and interprets the query. The server generates image data based on the query and returns this to the client. The client processes this data an displays a preview of the image at full size but reduced resolution (303). The user may subsequently choose a region of interest (304) and a query is constructed based on this choice (302). The server generates image data based on the query and returns this to the client, which processes this data and displays the improved representation of the image (303) to the user. This process continues until the user is satisfied with the image representation.

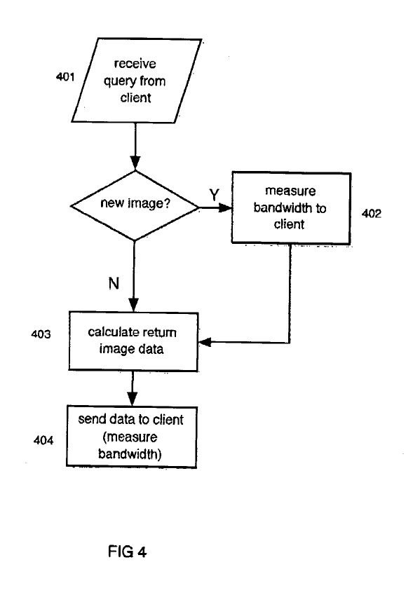

FIG. 4 illustrates one embodiment of a server side decision tree of the present invention. It should be apparent to one of ordinary skill in the art that some of the steps shown can be repeated, and other steps are variations or embellishments of the basic method of the invention, in other words not every step shown is necessary to work the invention.

The query from the client (302) is received in (401) and if this is the first query for a particular image, the network performance is measured between server and client (402). Based on the query and measured network performance, the server uses this data to calculate the largest data set size that can be transmitted over the communication link in a specified interval. The server generates image data in response to client requests such that the sets of image data transmitted have fewer elements that this maximum size (403). This data is sent to the client, and the transmission of this data is monitored to update the measurements of network performance (404).

What is claimed is:

1) A method of communicating image data between a server and a client connected to each other by a communication link, the method comprising;
transmitting an initial representation of image data from server to client which displays the data at full size (but possibly lower resolution),
receiving further queries using an image query syntax, and interpreting the query and measured network performance data and returning further image-data to the client, the client incorporates this data and displays an improved representation of the image.

2) A method according to claim 1, wherein the initial representation is a low-resolution preview of the image, and the image query syntax consists of user-specified region of interest rectangles.

3) A method according to claim 1, wherein the initial representation is an edge enhanced low-resolution preview of the image, and the image query syntax consists of user-specified region of interest rectangles.

4) A method according to claim 1, wherein the initial representation is a low-resolution preview of the image, and the image query syntax consists of user-specified shape identification requests.

5) A method according to claim 1, wherein the initial representation is an edge enhanced low-resolution preview of the image, and the image query syntax consists of user-specified shape identification requests.

6) A method according to claim 1, wherein the server uses measured communication-link performance to calculate the largest data set that can be transmitted over the communication link in a specified interval, and generates image data in response to client requests such that the sets of image data transmitted to the client have fewer elements that this maximum size.

7) A method according to claim 2, wherein the server uses measured communication-link performance to calculate the largest data set that can be transmitted over the communication link in a specified interval, and generates image data in response to client requests such that the sets of image data transmitted to the client have fewer elements that this maximum size.

8) A method according to claim 3, wherein the server uses measured communication-link performance to calculate the largest data set that can be transmitted over the communication link in a specified interval, and generates image data in response to client requests such that the sets of image data transmitted to the client have fewer elements that this maximum size.

9) A method according to claim 4, wherein the server uses measured communication-link performance to calculate the largest data set that can be transmitted over the communication link in a specified interval, and generates image data in response to client requests such that the sets of image data transmitted to the client have fewer elements that this maximum size.

10) A method according to claim 5, wherein the server uses measured communication-link performance to calculate the largest data set that can be transmitted over the communication link in a specified interval, and generates image data in response to client requests such that the sets of image data transmitted to the client have fewer elements that this maximum size.
